(19) United States
(12) Patent Application Publication
(10) Pub. No.: US 2025/0240853 A1
(43) Pub. Date: Jul. 24, 2025

(54) INDUCTION ENERGY TRANSMISSION SYSTEM

(71) Applicant: BSH Hausgeräte GmbH, Munich (DE)

(72) Inventors: Pablo Jesus Hernandez Blasco, Zaragoza (ES); Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/698,034

(22) PCT Filed: Sep. 20, 2022
(86) PCT No.: PCT/EP2022/076072

§ 371 Date: Apr. 3, 2024

(30) Foreign Application Priority Data
Oct. 6, 2021 (EP) 21382896

(51) Int. Cl. H05B 6/12; H02J 50/10

(52) U.S. Cl. CPC H05B 6/1236; H02J 50/10

(57) ABSTRACT

An induction energy transmission system includes a support plate, a supply unit arranged below the support plate and including a supply induction element for inductively providing energy, a control unit designed to supply the supply unit with energy and to modulate in an operating state a switching frequency for controlling the supply unit within a modulation period by frequency modulation, and a household appliance for placement on the support plate. The household appliance includes a receiving induction element designed to receive the inductively provided energy.

The invention relates to an induction energy transmission system according to the preamble of claim 1 and a method for operating an induction energy transmission system according to the preamble of claim 14.

Induction energy transmission systems for the inductive transmission of energy from a primary coil of a supply unit to a secondary coil of a support unit are already known from the prior art. For example, an induction cooktop which is provided for supplying energy to small household appliances, for example a blender, in addition to inductively heating items of cookware, is proposed in the publication U.S. Pat. No. 3,761,668 A. An energy provided inductively by a primary coil of the induction cooktop is partially transmitted to a secondary coil which is integrated in the small household appliance. Due to the large power spectrum for supplying energy to various small household appliances, a switching frequency for controlling and supplying energy to the supply unit can be varied over a particularly large range, in order to be able to set a supply power for a specific small household appliance as required. Depending on the switching frequency, undesired electromagnetic interference, for example noise or flicker, can occur here. This problem is already known from conventional induction cooktops for inductively heating items of cookware. For minimizing electromagnetic interference in conventional induction cooktops, therefore, the switching frequency is modulated within a modulation period, which corresponds to a maximum of half a period of a mains AC voltage, by means of a frequency modulation. Due to the very short duration of the modulation period, carrying out the frequency modulation is associated with a high degree of computing effort which requires a use of high-performance, application-specific integrated circuits and thus is associated with an increased cost. For induction energy transmission systems comprising a supply unit for inductively supplying energy to small household appliances, no specific solutions have been previously known for minimizing electromagnetic interference, such that an operating comfort of such hitherto known induction energy transmission systems is significantly limited in this regard.

The object of the invention, in particular but not limited thereto, consists in providing a generic system having improved properties regarding an operating comfort. The object is achieved according to the invention by the features of claims 1 and 14, while advantageous embodiments and developments of the invention can be found in the subclaims.

The invention is based on an induction energy transmission system, in particular an induction cooking system, comprising a support plate, a supply unit that is arranged below the support plate and includes at least one supply induction element for inductively providing energy, further comprising a control unit which controls in an operating state the supply unit and supplies it with energy, and comprising at least one small household appliance to be placed on the support plate, wherein the small household appliance has at least one receiving induction element for receiving the inductively provided energy.

It is proposed that the control unit modulates in the operating state a switching frequency for controlling the supply unit within at least one modulation period by means of at least one frequency modulation.

An induction energy transmission system having improved properties regarding an operating comfort, in particular regarding a convenient and/or reliable and/or low-noise operation, can be advantageously provided by means of such an embodiment. Advantageously, a compliance with EMC standards and/or a flicker conformity can be achieved by simple technical means. Advantageously, a spectral power density of the switching frequency can be reduced by means of the frequency modulation. Advantageously, flicker according to a flicker standard, in particular according to DIN EN 61000-3-3 Standard and/or IEC Standard 1000-3-3, can be at least largely, in particular substantially completely, avoided, in particular by an advantageous control of individual supply induction elements, or a plurality thereof. Moreover, it is possible to avoid a disadvantageous acoustic stress on an operator, whereby in particular it is possible to achieve a high level of operating comfort and in particular a positive operating impression for the operator, in particular regarding an acoustic quality. Moreover, the requirements for an EMV filter can be advantageously reduced, whereby material costs can be reduced.

The induction energy transmission system has a least one main functionality in the form of a wireless energy transmission, in particular in a wireless energy supply of small household appliances. In an advantageous embodiment, the induction energy transmission system is configured as an induction cooking system comprising at least one further main function deviating from a purely cooking function, in particular at least an energy supply and an operation of small household appliances. For example, the induction energy transmission system could be configured as an induction oven system and/or as an induction grill system. In particular, the supply unit could be configured as part of an induction oven and/or as part of an induction grill. In a particularly advantageous embodiment, the induction energy transmission system which is configured as the induction cooking system is configured as an induction cooktop system which comprises at least one cooktop, in particular an induction cooktop. The control unit and the supply unit are thus configured, in particular, as part of the cooktop, in particular the induction cooktop. In a further advantageous embodiment, the induction energy transmission system is configured as a small household appliance supply system which comprises at least one small appliance supply unit and, in addition to a main function in the form of supplying energy to and operating small household appliances, can be additionally provided for providing cooking functions. The control unit and the supply unit are thus configured, in particular, as part of the small appliance supply unit.

A “support plate” is intended to be understood to mean at least one, in particular plate-like, unit which is provided for placing at least one small household appliance and/or an item of cookware and/or for placing at least one food to be cooked. The support plate could be configured, for example, as a counter-top, in particular a kitchen counter-top, or as a sub-region of at least one counter-top, in particular at least one kitchen counter-top, in particular of the induction energy transmission system. Alternatively or additionally, the support plate could be configured as a cooktop plate. The support plate which is configured as the cooktop plate could form, in particular, at least one part of a cooktop external housing and could form, in particular, at least to a large extent the cooktop external housing together with at least one external housing unit to which the support plate, which is configured as the cooktop plate, could be connected, in particular, in at least one mounted state. Preferably, the support plate is produced from a non-metallic material. The support plate could be formed, for example, at least to a large extent from glass and/or from glass ceramic and/or from neolith and/or from Dekton and/or from wood and/or from marble and/or from stone, in particular from natural stone, and/or from laminate and/or from plastic and/or from ceramic. In the present document, positional references such as for example “below” or “above” refer to a mounted state of the support plate, provided this is not explicitly described otherwise.

A “supply unit” is intended to be understood to mean a unit which in at least one operating state provides energy inductively and which, in particular, has a main functionality in the form of providing energy. For providing energy, the supply unit has at least one supply induction element which has at least one coil, in particular at least one primary coil, and/or is configured as a coil and which, in particular, in the operating state provides energy inductively. The supply unit could have at least two, in particular at least three, advantageously at least four, particularly advantageously at least five, preferably at least eight and particularly preferably a plurality of supply induction elements which in the operating state in each case could provide energy inductively, and namely in particular to a single receiving induction element or to at least two or more receiving induction elements of at least one small household appliance and/or at least one further small household appliance. At least some of the supply induction elements could be arranged in the vicinity of one another, for example in a row and/or in the form of a matrix.

A “control unit” is intended to be understood to mean an electronic unit which in the operating state controls and supplies energy to at least one supply induction element of the supply unit, in particular repeatedly with a switching frequency. Preferably, the control unit for controlling and supplying energy to the at least one supply induction element has at least one inverter which can be configured, in particular, as a resonance inverter and/or as a dual half-bridge inverter. The inverter preferably comprises at least two switching elements which can be controlled individually by the control unit. A “switching element” is intended to be understood to mean an element which is provided to produce and/or disconnect an electrically conductive connection between two points, in particular contacts, of the switching element. Preferably, the switching element has at least one control contact via which it can be switched. Preferably, the switching element is configured as a semi-conductor switching element, in particular as a transistor, for example as a metal-oxide semi-conductor field effect transistor (MOSFET) or organic field effect transistor (OFET), advantageously as a bipolar transistor, with a preferably insulated gate electrode (IGBT). Alternatively, it is conceivable that the switching element is configured as a mechanical and/or electromechanical switching element, in particular as a relay. Preferably, the control unit comprises a computing unit and, in particular in addition to the computing unit, a memory unit comprising at least one control program which is stored therein and which is provided to be executed by the computing unit.

Preferably, in the operating state the control unit modulates the switching frequency continuously within an operating period which corresponds at least to a modulation period, preferably a plurality of successive modulation periods. It is conceivable that the operating period of the induction target corresponds to an entire operating period of the induction energy transmission system, i.e. a time period in which the induction energy transmission system is continuously operated. It is also conceivable that the control unit operates a plurality of supply induction elements of the supply unit alternately in a time-multiplex mode. In the time-multiplex mode, the operating period corresponds to the time period in which the control unit continuously controls and supplies energy to a specific supply induction element or a plurality of specific supply induction elements simultaneously at the switching frequency.

Preferably, for generating an alternating magnetic field and for supplying it with electrical energy, the control unit controls at least one supply induction element with an electrical alternating current, the switching frequency thereof preferably ranging from 20 kHz to 150 kHz and particularly preferably ranging from 30 kHz to 75 kHz.

A “modulation period” is intended to be understood to mean a time period in which the control unit modulates the switching frequency by implementing at least one frequency modulation.

A “frequency modulation” is intended to be understood to mean a modulation method on the basis of which the control unit varies the switching frequency. Preferably, the frequency modulation comprises at least one method which is known by the term “frequency spread” or by the English terms “spread spectrum” or “spread spectrum clocking”. The frequency modulation is provided to reduce, preferably to minimize, interference which in an operating state of the household appliance device can be caused, for example, by individual peaks of the switching frequency. Interference can be influences which are able to be perceived by a user and regarded as undesirable and/or influences which are prohibited by legal regulations. For example, interference could be in the form of flicker. Alternatively or additionally, interference could be undesirable acoustic influences, in particular in a frequency range of between 20 Hz and 20 kHz which is able to be perceived by an average human ear. Interference could be caused, in particular, by intermodulations and could be manifested as perceptible acoustic interference noise. “Intermodulations” are intended to be understood to mean sum products or difference products of individual AC frequencies or the n-th harmonics thereof, wherein n represents an integer greater than zero. Alternatively or additionally, interference can also be caused by an occurrence of a ripple current, i.e. an alternating current of any frequency and curve shape which is superimposed onto a direct current and manifested as an undesirable humming tone. Interference in this context does not include any technical malfunctions and/or defects.

Preferably, the small household appliance is a location-independent household appliance which has at least the receiving induction element and at least one functional unit which provides at least one household appliance function in an operating state. “Location-independent” is intended to be understood to mean in this context that the small household appliance can be freely positioned in a household by a user and, in particular, without the use of tools, in particular in contrast to a large household appliance which is fixedly positioned and/or installed at a specific position in a household, such as for example an oven or a refrigerator. Preferably, the small household appliance is configured as a small kitchen appliance and in the operating state provides at least one household appliance function for processing food. The small household appliance could be configured, for example, without being limited thereto, as a multi-function food processor and/or as a blender and/or as a mixer and/or as a grinder and/or as kitchen scales or as a kettle or as a coffee machine or as a rice cooker or a milk frother or as a deep-fat fryer or as a toaster or as a juicer or as a food slicer, or the like. The receiving induction element comprises at least one secondary coil and/or is configured as a secondary coil. In an operating state of the small household appliance, the receiving induction element supplies the functional unit with electrical energy. Moreover, it is conceivable that the small household appliance has an energy storage device, in particular an accumulator, which is provided in a charging state to store electrical energy received by the receiving induction element, and in a discharging state to supply electrical energy to the functional unit.

Preferably, the induction energy transmission system has a communication unit for wireless communication between the control unit and the small household appliance. It might be conceivable that the communication unit has at least one inductive communication element which is configured separately from the supply induction element and is connected to the control unit. A wireless communication could then be carried out between the inductive communication element and the receiving induction element, or a further inductive communication element of the communication unit which is arranged in the small household appliance, by means of inductive communication signals. The communication unit could alternatively or additionally be provided for a wireless data transmission between the control unit and the small household appliance by RFID, or by WIFI, or by Bluetooth or by ZigBee or for wireless data transmission according to a different suitable standard. Preferably, the communication unit is provided for a wireless data transmission between the support unit and the control unit by NFC. The communication unit is preferably provided for a bidirectional wireless data transmission, i.e. both for wireless reception and for wireless transmission of data. Preferably, the communication unit has at least one communication element which is connected to the control unit and, in particular, for a wireless reception and transmission of data. Preferably, the communication unit has at least one further communication element which is arranged within the small household appliance and, in particular, is provided for a wireless reception and transmission of data.

In the present application, numerical terms, such as for example “first” and “second”, which are placed before certain words merely serve for differentiating objects and/or an assignment of objects to one another, and do not imply an existing total number and/or ranking of the objects. In particular, a “second object” does not necessarily imply a presence of a “first object”.

“Provided” is intended to be understood to mean specifically programmed, designed and/or equipped. An object being provided for a specific function is intended to be understood to mean that the object fulfills and/or executes this specific function in at least one use state and/or operating state.

It is further proposed that the modulation period corresponds to an integer multiple of a half period of a mains AC voltage. If the modulation period corresponds to an integer multiple of the half period of the mains AC voltage, advantageously a temporary computing effort for carrying out the frequency modulation can be reduced. As a result, it is conceivable that application-specific integrated circuits (ASIC-chip) can be replaced by simpler and more cost-effective circuits. By the cost savings thus achieved, advantageously a particularly inexpensive induction energy transmission system can be provided with the aforementioned advantageous properties regarding an operating comfort and/or a safety. The modulation period corresponds to an integer multiple of a half period of a mains AC voltage, wherein the period of the mains AC voltage corresponds to the reciprocal value of the mains frequency. In Europe a mains AC voltage is typically provided at a mains frequency of 50 Hz, so that a half period of the mains AC voltage in this case is 10 ms. In cases in which the household appliance device is supplied with a mains AC voltage at a mains frequency which deviates from 50 Hz, the control unit is provided to adapt the duration of the modulation period to the correspondingly changed period of the mains AC voltage and to select it as a corresponding integer multiple of half of the changed period.

Alternatively, a duration of the modulation period could also be different from an integer multiple of the half period of the mains AC voltage and, for example, less than or equal to the half period of the mains AC voltage and/or a multiple of the half period of the mains AC voltage from the set of rational numbers and/or the set of real numbers.

It is further proposed that the modulation period comprises at least two modulation intervals which are, in particular, different from one another and which in each case correspond to an integer multiple of a half period of a mains AC voltage. As a result, a particularly accurate frequency modulation can be advantageously achieved. Preferably, the modulation period comprises a plurality of modulation intervals which, in particular, are different from one another and which in each case correspond to an integer multiple of a half period of a mains AC voltage. It might be conceivable that the at least two modulation intervals correspond to different multiples of the half period of the mains AC voltage. For example, a first modulation interval could correspond to two times, and a further modulation interval to four times, the half period of the mains AC voltage. Preferably, all of the modulation intervals within a modulation period in each case correspond to the same multiple, particularly preferably two times, of the half period of the mains AC voltage. The modulation intervals can differ from one another, for example, regarding an amount and/or regarding a sign of a variation in the switching frequency. For example, in the first modulation interval the control unit could vary the switching frequency by a specific first amount and in a further modulation interval the control unit could vary the switching frequency by a further amount which, for example, is larger or smaller than the first amount and/or has an opposing sign relative to the first amount.

It is further proposed that the control unit in the operating state modulates the switching frequency on the basis of at least one predefined modulation profile. As a result, advantageously, interference can be reduced in a particularly targeted manner. Moreover, a computing effort for the control unit can be advantageously reduced. The predefined modulation profile can be understood as a basic time curve of the frequency modulation within a modulation period which is stored, in particular, in the memory unit of the control unit. The predefined modulation profile could define, for example, a frequency value range of the switching frequency in which the control unit modulates the switching frequency within the modulation period.

For example, the predefined modulation profile could comprise a maximum and/or minimum switching frequency which cannot be exceeded or fallen below by the control unit or is not intended to be exceeded or fallen below by the control unit. Alternatively or additionally, the modulation profile could contain, for example, a maximum and/or minimum percentage variation of an output switching frequency. Additionally, it is conceivable that the modulation profile comprises, in particular, experimentally determined, specific switching frequency values, in particular specific switching frequency values of individual, in particular all, modulation intervals of the modulation period. Preferably, a plurality of different predefined modulation profiles are stored in the memory unit of the control unit, said modulation profiles being able to be automatically recalled by the control unit, in particular on the basis of a selection made by a user of a specific operating mode and/or a target power for operating the small household appliance provided by at least one supply induction element of the supply unit. Alternatively or additionally, it might also be conceivable that in the operating state the small household appliance wirelessly transmits at least one modulation profile, which is designed in particular specifically for the small household appliance, to the control unit by means of the communication unit. The control unit modulating the switching frequency “using at least one predefined modulation profile” is intended to be understood to mean that the control unit at least takes into account the predefined modulation profile for the frequency modulation. The predefined modulation profile can be provided in this case as a template for the frequency modulation to be carried out by the control unit, wherein the control unit can change the frequency modulation on the basis of the predefined modulation profile and, in particular, adapt it to an individual operating situation, for example to a specific type of small household appliance and/or a specific operating mode and/or a number of supply induction elements to be operated at the same time and/or a target power, or the like, selected by a user.

The modulation profile could be, for example, a rectangular or saw-tooth-shaped profile and have discontinuous points with larger jumps in the switching frequency. In an advantageous embodiment, however, it is proposed that the modulation profile is able to be described by a continuous mathematical function. Advantageously, an occurrence of flicker can be reduced, preferably minimized, thereby. Since a change of switching frequencies in electrical components is discrete, and thus cannot take place in infinitesimally small steps, as might be required according to a strict mathematical definition of continuity, in this context the modulation profile is intended to be considered as continuous only within the context of a resolution of the switching frequency, i.e. a minimum step of change between two directly successive switching frequencies. Preferably, the minimum step between two directly successive switching frequencies of the modulation profile, which is able to be described by a substantially continuous switching frequency, is at least 1 Hz, advantageously at least 2 Hz, particularly advantageously at least 4 Hz and a maximum of 8 Hz. In particular, the continuous mathematical function contains all discrete points of the modulation profile as functional values so that the modulation profile is able to be described by the continuous mathematical function.

It is further proposed that the modulation profile within the modulation period has a path which is linear at least in some portions. Due to a modulation profile which is linear at least in some portions, advantageously interference can be reduced, preferably minimized, in a particularly reliable manner during the operation of the induction energy transmission system, such as for example acoustic interference noise or the like. A “path which is linear at least in some portions” is intended to be understood to mean in this case that the modulation profile has at least a portion consisting of a plurality of at least three successive modulation intervals in which the switching frequency is changed by the control unit, in each case by the same amount. For example, the modulation period could have a portion which consists of at least three successive modulation intervals in which the control unit raises the switching frequency in each case by a value of 1 Hz. The modulation profile can have a plurality of portions which have in each case a linear path, wherein the linear portions could have slopes which are different from one another. For example, the control unit could raise the switching frequency in a first linear portion of the modulation profile, consisting of at least three successive modulation intervals, in each of the modulation intervals by 1 Hz, and in each case raise the switching frequency by 2 Hz in a subsequent second linear portion of the modulation profile, consisting of at least three further successive modulation intervals.

In a further advantageous embodiment, it is proposed that the modulation profile within the modulation period has a path which is exponential at least in some portions. Due to a modulation profile which is exponential at least in some portions, advantageously interference during an operation of the induction energy transmission system, such as acoustic interference noise or the like, can be reduced, preferably minimized, in a particularly efficient manner. A “path which is exponential at least in some portions” is intended to be understood to mean in this case that the modulation profile has a plurality of at least three successive modulation intervals in which the switching frequency is changed by the control unit in each case by different amounts, the path thereof being able to be described by an exponential function. For example, the modulation period could have a portion which consists of at least three successive modulation intervals in which the control unit raises the switching frequency in the first of the successive modulation intervals by 2 Hz, in the second of the successive modulation intervals by 4 Hz and in the third of the successive modulation intervals by 8 Hz.

Moreover, it is proposed that the modulation profile within the modulation period is mirror-symmetrical at least in some portions. Advantageously, an occurrence of interference, in particular flicker, can be further reduced thereby. In addition, advantageously a desired target power for supplying the small household appliance can be set in a particularly accurate manner. The modulation profile which is mirror-symmetrical at least in some portions could have, for example, a first portion in which the switching frequency has a path which is, for example, linear or exponential and which is able to be described by a first mathematical function, and a second portion which is immediately adjacent to the first portion and which is able to be described by a second mathematical function which can be transferred into the first mathematical function by reflection on an axis of symmetry.

It is further proposed that the control unit is provided to vary the modulation profile at least on the basis of a parameter relating to the small household appliance. Advantageously, the frequency modulation can be adapted in a particularly simple manner to an individual operating situation, in particular an individual operation of various small household appliances, by means of such an embodiment. It is conceivable that the control unit has at least one sensor unit for detecting the parameter relating to the small household appliance. The parameter relating to the small household appliance could be, for example, a temperature of the small household appliance and/or a region of the support plate on which the small household appliance is placed in the operating state and/or an operating period of the small household appliance, or the like. Preferably, the parameter relating to the small household appliance is an electrical parameter of the small household appliance and/or an influence of the small household appliance on at least one electrical parameter of the supply unit. The parameter relating to the small household appliance could be, for example, an electrical parameter of the receiving induction element, in particular an inductance and/or an electrical resistance and/or an impedance and/or a capacitance and/or electrical voltage and/or current strength and/or an electrical power and/or a resonance frequency of the receiving induction element and/or at least one component connected to the receiving induction element. Preferably, the electrical parameter of the small household appliance comprises at least one electrical power of the small household appliance, in particular a minimum power and/or a maximum power, preferably a target power currently set by a user. In an advantageous embodiment, it is proposed that the parameter comprises an influence of the small household appliance on an impedance of at least one supply induction element of the supply unit. As a result, advantageously a desired target power of the small household appliance can be set particularly efficiently and accurately. Due to the frequency modulation of the switching frequency, the impedance of the at least one supply induction element of the supply unit changes, and within the modulation period in some portions can have an excess and in some portions a deficit relative to a desired impedance which corresponds to the set target power. Preferably, the control unit varies the modulation profile such that the impedance of the supply induction element is constant when averaged over the modulation period.

In a further advantageous embodiment, it is proposed that the control unit in the operating state additionally modulates the switching frequency within an intermediate modulation period which corresponds to a maximum of the half period of the mains AC voltage, by means of at least one further frequency modulation. As a result, advantageously an occurrence of interference, which in particular can be caused by harmonics of an alternating current of the supply network, can be reduced and preferably minimized.

It is further proposed that the induction energy transmission system has a cooktop which comprises the control unit and the supply unit. An induction energy transmission system which is configured as an induction cooking system can be provided with the aforementioned advantageous properties by means of such an embodiment, said induction energy transmission system also permitting an inductive heating of items of cookware in addition to an inductive supply of energy to small household appliances by the supply unit according to the above-described embodiments.

In an alternative advantageous embodiment, it is proposed that the induction energy transmission system has a small appliance supply unit which comprises the control unit and the supply unit. An induction energy transmission system can be provided with the aforementioned advantageous properties and with a particularly high degree of flexibility and functionality by means of such an embodiment. In this embodiment, the support plate is preferably configured as a kitchen counter-top. As a result, advantageously an enthusiasm for inductive energy transmission can be increased when the support plate is configured as a kitchen counter-top, since some components of the induction energy transmission system, in particular the small appliance supply unit, remain completely invisible to a user below the kitchen counter-top and thus the impression can be provided that the small household appliance is operated without any energy source. Moreover, in this embodiment the induction energy transmission system could also be provided for inductively heating items of cookware, in addition to inductively supplying energy to small household appliances.

The invention is further based on a method for operating an induction energy transmission system, in particular according to one of the above-described embodiments, comprising a support plate, a supply unit that is arranged below the support plate and includes at least one supply induction element for inductively providing energy, and comprising at least one small household appliance to be placed on the support plate, wherein the small household appliance has at least one receiving induction element for receiving the inductively provided energy.

It is proposed that a switching frequency for controlling the supply unit within at least one modulation period is modulated by means of at least one frequency modulation. The induction energy transmission system can advantageously be operated particularly efficiently by means of such an embodiment. Additionally, the induction energy transmission system can advantageously be operated particularly reliably and/or conveniently, in particular with low noise and compliance with EMC and flicker standards. Preferably, the switching frequency for controlling the supply unit within a modulation period, which corresponds to an integer multiple of a half period of the mains AC voltage, is modulated by means of at least one frequency modulation. Alternatively, the switching frequency for controlling the supply unit within a modulation period, which is less than or equal to the half period of the mains AC voltage and/or corresponds to a multiple of the half period of the mains AC voltage from the set of rational numbers and/or the set of real numbers, could be modulated by means of at least one frequency modulation.

The induction energy transmission system is not intended to be limited herein to the above-described use and embodiment. In particular, for fulfilling a mode of operation described herein the induction energy transmission system can have a number of individual elements, components and units which deviates from a number mentioned herein.

Further advantages are found in the following description of the drawing. Two exemplary embodiments of the invention are shown in the drawing. The drawing, the description and the claims contain numerous features in combination. The person skilled in the art will also expediently consider the features individually and combine them to form further meaningful combinations.

In the drawing:

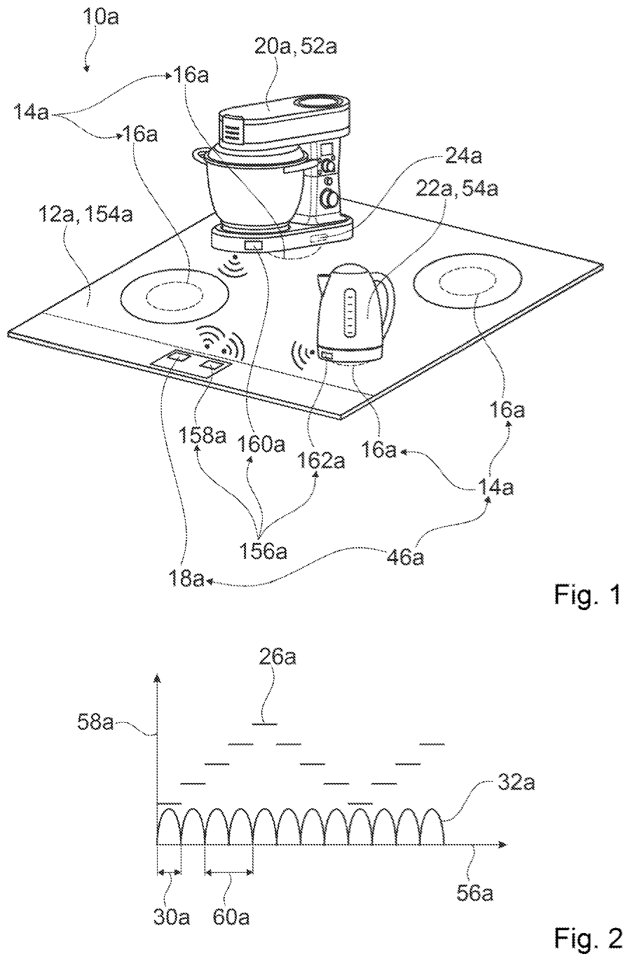

FIG. 1 shows an induction energy transmission system comprising a support plate, a supply unit, a control unit and two small household appliances placed on the support plate, in a schematic view,

FIG. 2 shows a schematic diagram for representing a time curve of a switching frequency, the control unit in an operating state controlling and supply energy to the supply unit,

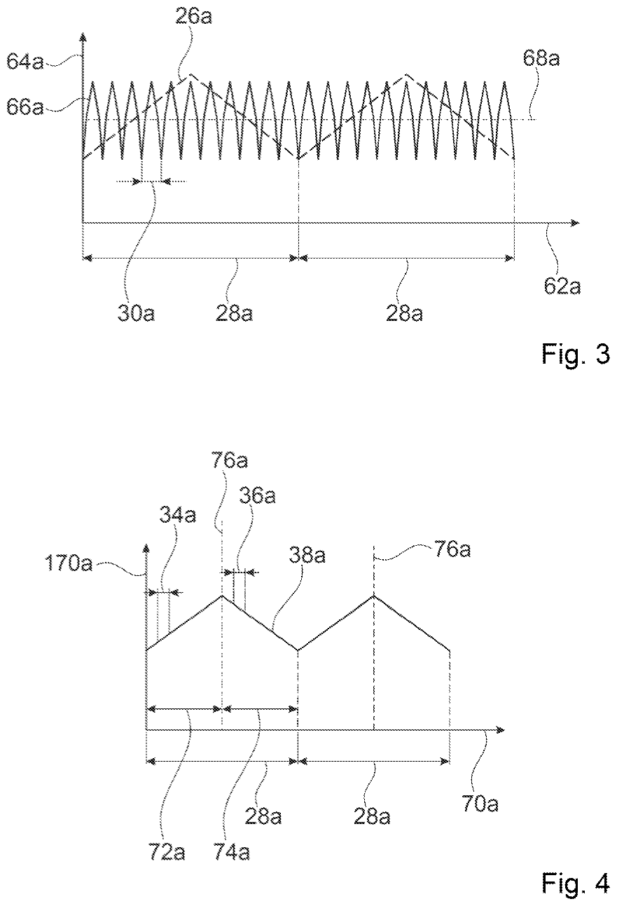

FIG. 3 shows a schematic diagram for representing a modulation period within which the control unit modulates the switching frequency,

FIG. 4 shows a schematic diagram for representing a modulation profile, on the basis of which the control unit modulates the switching frequency within the modulation period,

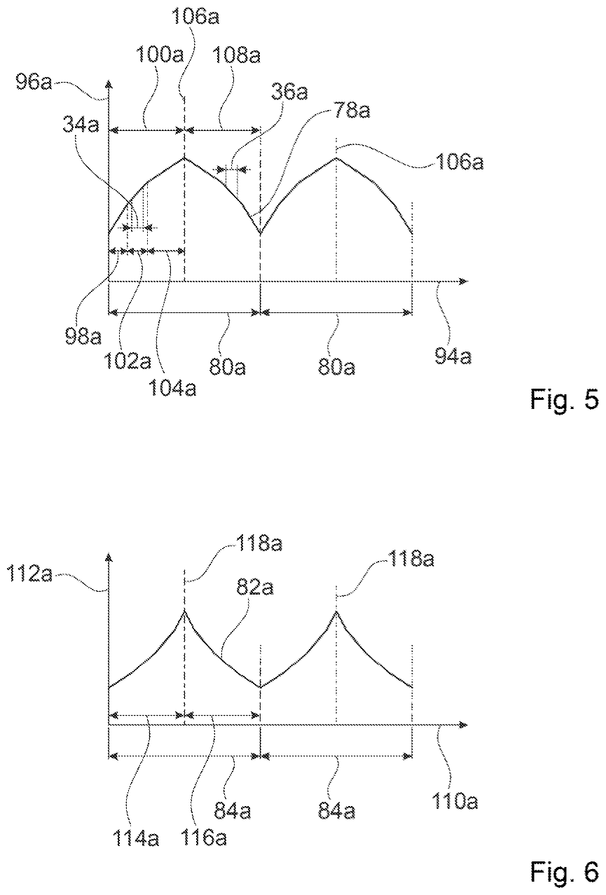

FIG. 5 shows a schematic diagram for representing a first further modulation profile, on the basis of which the control unit modulates the switching frequency in a first further modulation period,

FIG. 6 shows a schematic diagram for representing a second further modulation profile, on the basis of which the control unit modulates the switching frequency in a second further modulation period,

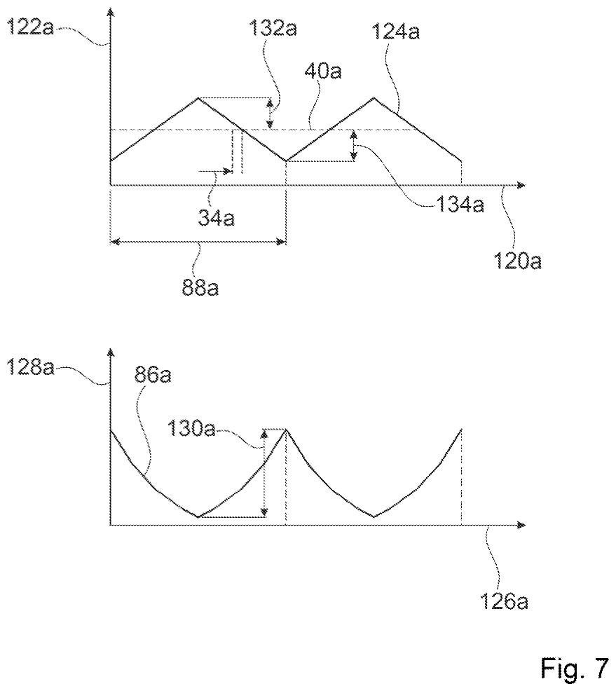

FIG. 7 shows two schematic diagrams for representing a third further modulation profile, on the basis of which the control unit modulates the switching frequency in a third further modulation period,

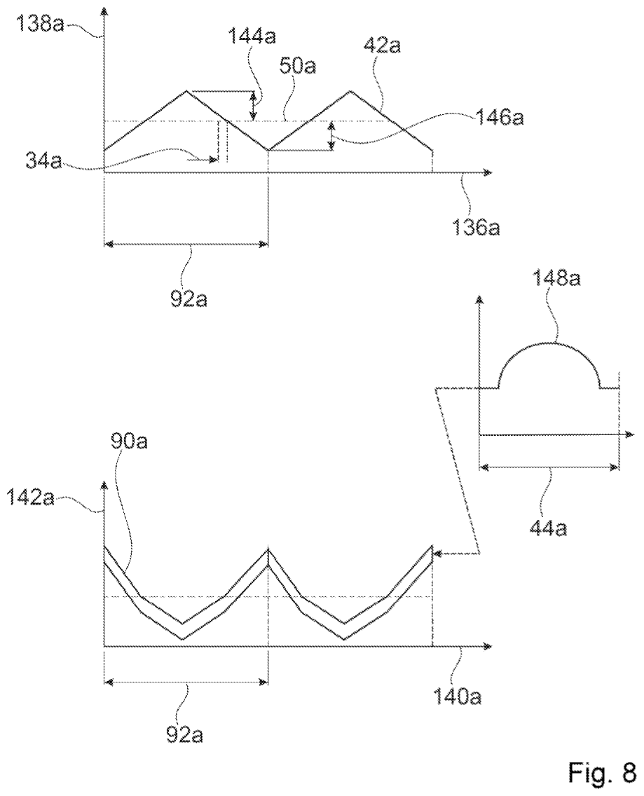

FIG. 8 shows two schematic diagrams for representing a fourth further modulation profile, on the basis of which the control unit modulates the switching frequency in a fourth further modulation period,

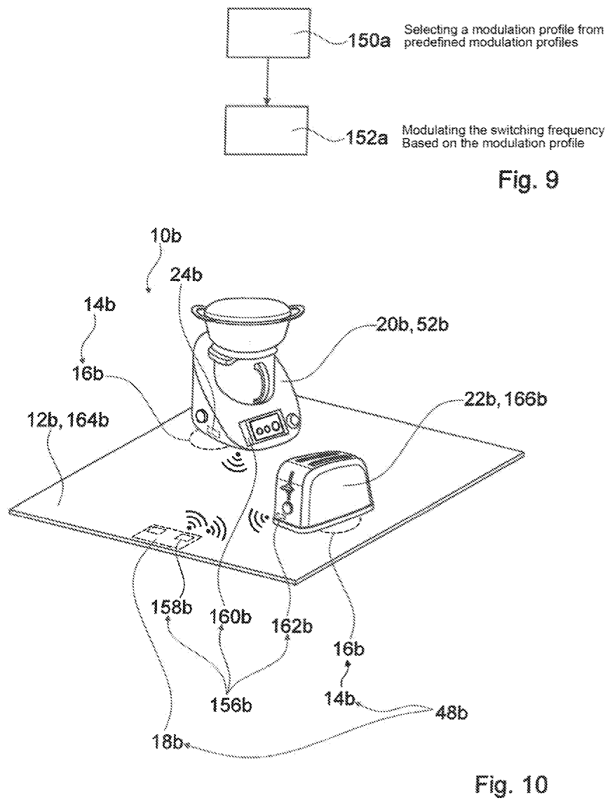

FIG. 9 shows a schematic process flow diagram of a method for operating the induction energy transmission system and

FIG. 10 shows a further exemplary embodiment of an induction energy transmission system comprising a support plate, a supply unit, a control unit and two small household appliances placed on the support plate, in a schematic view.

FIG. 1 shows an induction energy transmission system 10a in a schematic view. The induction energy transmission system 10a comprises a support plate 12a and a supply unit 14a. The supply unit 14a is arranged below the support plate 12a and has at least one supply induction element 16a for inductively providing energy. In the present case, the supply unit 14a comprises a total of four supply induction elements 16a which are arranged below the support plate 12a. The induction energy transmission system 10a comprises a control unit 18a which controls in an operating state the supply unit 14a and supplies it with energy. The control unit 18a comprises an inverter (not shown) for controlling and supplying energy to the supply unit 14a. The control unit 18a in the operating state supplies the supply unit 14a with an electrical energy in the form of a supply alternating current 66a (see FIG. 3), the frequency thereof corresponding to a switching frequency 26a (see FIG. 3) by which the control unit 18a operates the inverter.

The induction energy transmission system 10a is configured in the present case as an induction cooking system and comprises a cooktop 46a. The cooktop 46a is configured as an induction cooktop. In the present case, the support plate 12a is configured as a cooktop plate 154a. The cooktop plate 154a is part of the cooktop 46a. In the present case, the cooktop 46a comprises the control unit 18a and the supply unit 14a.

The induction energy transmission system 10a comprises at least one small household appliance 20a to be placed on the support plate 12a. The small household appliance 20a has at least one receiving induction element 24a. The receiving induction element 24a is provided for receiving an inductively provided energy. In the present case, the receiving induction element 24a is provided for receiving the energy inductively provided by the supply induction element 16a. In the present case, the induction energy transmission system 10a comprises the small household appliance 20a and a further small household appliance 22a. The small household appliance 20a is configured as a food processor 52a and, amongst other things, for blending and/or mixing food. The further small household appliance 22a is configured as a kettle 54a.

The induction energy transmission system 10a has a communication unit 156a for wireless communication between the control unit 18a and the small household appliance 20a and/or the further small household appliance 22a. The communication unit 156a has a communication element 158a which is connected to the control unit 18a and two further communication elements 160a, 162a which are arranged in the small household appliance 20a or in the further small household appliance 22a. In the present case, the communication unit 156a is configured as an NFC communication unit and is provided for wireless communication by NFC between the control unit 18a and the small household appliance 20a and/or the further small household appliance 22a.

FIG. 2 shows a schematic diagram for representing by way of example a time curve of the switching frequency 26a, the control unit 18a in the operating state controlling thereby the supply unit 14a and supplying it with energy. A time is plotted in milliseconds on an x-axis 56a of the diagram. The switching frequency 26a is plotted in kilohertz on a y-axis 58a of the diagram. A curve shows a time path of a mains AC voltage 32a which has been rectified by a rectifier (not shown) of the control unit 12a and namely such that an instantaneous value of the mains AC voltage 32a changes within a half period 30a, but the mains AC voltage 32a does not change its electrical polarity within one period 60a consisting of two half periods 30a. In the present case, the mains AC voltage 32a has a frequency of 50 Hz so that the period 60a lasts 20 milliseconds and the half period 30a correspondingly lasts 10 milliseconds.

In the operating state, the control unit 18a modulates the switching frequency 26a within at least one modulation period 28a (see FIG. 3) by means of at least one frequency modulation. In the present case, the modulation period 28a corresponds to an integer multiple of the half period 30a of the mains AC voltage 32a.

In FIG. 3 a diagram is shown for a schematic representation of the modulation period 28a within which the control unit 18a modulates the switching frequency 26a by means of at least one frequency modulation. A time is plotted in milliseconds on an x-axis 62a of the diagram. The switching frequency 26a is plotted in kilohertz and the supply alternating current 66a is plotted in amperes on a y-axis 64a. The modulation period 28a corresponds to an integer multiple, in the present case eleven times, the half period 30a of the mains AC voltage 32a. Averaged over the modulation period 28a, the switching frequency 26a corresponds to an average switching frequency 68a which corresponds to an average power inductively provided by the supply induction element 16a.

FIG. 4 shows a diagram for representing a modulation profile 38a, the control unit 18a modulating thereby the switching frequency 26a within the modulation period 28a. A time is plotted in milliseconds on an x-axis 70a of the diagram. The switching frequency 26a is plotted in kilohertz on a y-axis 170a of the diagram.

The modulation period 28a comprises a plurality of successive modulation intervals 34a, 36a which in the present case correspond to an integer multiple of the half period 30a of the mains AC voltage 32a. In FIG. 4 two of the modulation intervals 34a, 36a are illustrated by way of example. The switching frequency 26a rises within the modulation interval 34a. The switching frequency 36a reduces within the modulation interval 36a.

In the operating state, the control unit 18a modulates the switching frequency 26a on the basis of the predefined modulation profile 38a. The modulation profile 38a is able to be described by a continuous mathematical function. The modulation profile 38a within the modulation period 28a has a path which is linear at least in some portions. Within a first portion 72a of the modulation period 28a, the modulation profile 38a has a linear and continuously rising path with an increasing switching frequency 26a. Within a second portion 74a the modulation profile 38a has a linear and continuously falling path with a reducing switching frequency 26a. The modulation profile 38a is mirror-symmetrical in at least some portions. In the present case, the modulation profile 38a is mirror-symmetrical relative to an axis of symmetry 76a so that the path of the modulation profile 38a in the second portion 74a is produced by reflection of the path in the first portion 72a on the axis of symmetry 76a.

After the modulation period 28a has expired, it is repeated again and the control unit 12a modulates the switching frequency 26a again on the basis of the modulation profile 38a.

FIG. 5 shows a schematic diagram for representing a first further modulation profile 78a, the control unit 18a modulating thereby the switching frequency 26a within a first further modulation period 80a following the modulation period 28a by means of a further frequency modulation. The first further modulation period 80a corresponds to an integer multiple of the half period 30a of the mains AC voltage 32a. A time is plotted in milliseconds on an x-axis 94a of the diagram. The switching frequency 26a is plotted in kilohertz on a y-axis 96a of the diagram.

The first further modulation profile 78a is able to be described by a continuous mathematical function. The first further modulation profile 78a within the first further modulation period 80a has a path which is linear at least in some portions. Within a first sub-portion 98a of a first portion 100a of the first further modulation period 80a, the first further modulation profile 78a has a linear and continuously rising path with an increasing switching frequency 26a. Within a second sub-portion 102a of the first portion 100a of the first further modulation period 80a, the first further modulation profile 78a has a linear and continuously rising path with a flatter rise in the switching frequency 26a relative to the first sub-portion 98a. Within a third sub-portion 104a of the first portion 100a of the first further modulation period 80a, the first further modulation profile 78a has a linear and substantially continuous path with a flatter rise in the switching frequency 26a relative to the second sub-portion 102a.

The first further modulation profile 78a is mirror-symmetrical at least in some portions. In the present case, the first further modulation profile 78a is mirror-symmetrical relative to an axis of symmetry 106a such that a path of the first further modulation profile 78a in a second portion 108a is produced by reflection of the path in the first portion 100a on the axis of symmetry 106a.

FIG. 6 shows a schematic diagram for representing a second further modulation profile 82a, the control unit 18a modulating thereby the switching frequency 26a within a second further modulation period 84a following the first further modulation period 78a, by means of a further different frequency modulation. The second further modulation period 84a corresponds to an integer multiple of the half period 30a of the mains AC voltage 32a. A time is plotted in milliseconds on an x-axis 110a of the diagram. The switching frequency 26a is plotted in kilohertz on a y-axis 112a of the diagram.

The second further modulation profile 82a is able to be described by a continuous mathematical function. The second further modulation profile 82a within the second further modulation period 84a has a path which is exponential at least in some portions. Within a first portion 114a of the second further modulation period 84a, the second further modulation profile 82a has a substantially continuous path with an exponentially increasing switching frequency 26a. Within a second portion 116a of the second further modulation period 84a, the second further modulation profile 82a has a continuous path with an exponentially reducing switching frequency 26a.

The second further modulation profile 82a is mirror-symmetrical at least in some portions. In the present case, the second further modulation profile 82a is mirror-symmetrical relative to an axis of symmetry 118a such that a path of the second further modulation profile 82a in the second portion 116a is produced by reflection of the path in the first portion 114a on the axis of symmetry 118a.

FIG. 7 shows two schematic diagrams for representing a third further modulation profile 86a, the control unit 18a modulating thereby the switching frequency 26a within a third further modulation period 88a following the second further modulation period 84a by means of a further different frequency modulation. The third further modulation period 88a corresponds to an integer multiple of the half period 30a of the mains AC voltage 32a. A time is plotted in milliseconds on an x-axis 120a of an upper diagram. A power 124a is plotted in watts on a y-axis 122a of the upper diagram. The time is plotted in milliseconds on an x-axis 126a of a lower diagram. The switching frequency is plotted in kilohertz on a y-axis 128a of the lower diagram.

The control unit 18a is provided to vary the third further modulation profile 86a at least on the basis of a parameter 40a relating to the small household appliance 20a or the further small household appliance 22a. In the present case, the parameter 40a is a target power which is set by a user and which is intended to be provided by the supply induction element 16a for supplying the small household appliance 20a. A general path of the third further modulation profile 86a is continuous, and linear in some portions, and can be observed as an inverse of a general path of the first further modulation profile 78a (see FIG. 5). On the basis of the parameter 40a, in the operating state the control unit 18a varies a frequency value range 130a of the third further modulation profile 86a such that the path of the power 124a shown in the upper diagram is produced. Due to the frequency modulation of the switching frequency 26a, the power 124a changes and has in some portions an excess 132a and in some portions a deficit 134a so that, when observed over the third further modulation period 88a, the target power corresponds on average to the target power set by the user.

FIG. 8 shows two schematic diagrams for representing a fourth further modulation profile 90a, the control unit 18a modulating thereby the switching frequency 26a within a fourth further modulation period 92a following the third further modulation period 88a by means of a further different frequency modulation. The fourth further modulation period 92a corresponds to an integer multiple of the half period 30a of the mains AC voltage 32a. A time is plotted in milliseconds on an x-axis 140a of a lower diagram. The switching frequency 26a is plotted in kilohertz on a y-axis 142a of the lower diagram. The time is plotted in milliseconds on an x-axis 136a of an upper diagram. An impedance 42a of the supply induction element 16a is plotted on a y-axis 138a of the upper diagram.

The fourth further modulation profile 90a substantially differs from the third further modulation profile 86a regarding a parameter 50a relating to the small household appliance 20a which the control unit 18a uses as a basis for varying the fourth further modulation profile 90a. The parameter 50a comprises an influence of the small household appliance 20a on the impedance 42a of the supply induction element 16a. On the basis of the parameter 50a, the control unit 18a varies the fourth further modulation profile 90a resulting in the path of the impedance 42a shown in the upper diagram. Due to the frequency modulation of the switching frequency 26a, the impedance 42a changes and has in some portions an excess 144a and in some portions a deficit 146a. The control unit 18a varies the fourth further modulation profile 90a such that the impedance 42a is constant when averaged over the fourth further modulation period 92a.

The control unit 18a in the operating state additionally modulates the switching frequency 26a within an intermediate modulation period 44a which corresponds to a maximum of the half period 30a of the mains AC voltage 32a, by means of at least one further frequency modulation. In the operating state, in addition to the above-described frequency modulation on the basis of the fourth further modulation profile 90a, within the intermediate modulation period 44a the control unit 18a varies the switching frequency 26a briefly and within the half period 30a of the mains AC voltage 32a on the basis of an intermediate modulation profile 148a shown in FIG. 8, in order to prevent the occurrence of flicker.

FIG. 9 shows a schematic process flow diagram of a method for operating an induction energy transmission system 10a. In the method, the switching frequency 26a for controlling the supply unit 14a within at least one of the modulation periods 28a, 80a, 84a, 88a, 92a, which corresponds to an integer multiple of the half period 30a of a mains AC voltage 32a, is modulated by means of at least one frequency modulation. The method comprises at least two method steps 150a, 152a. In a first method step 150a of the method, a modulation profile which is suitable for a current operating situation is selected from the predefined modulation profiles 38a, 78a, 82a, 86a, 90a. In a second method step 152a of the method, the switching frequency 26a is modulated within at least one of the modulation periods 28a, 80a, 84a, 88a, 92a, on the basis of at least one of the predefined modulation profiles 38a, 78a, 82a, 86a, 90a.

In FIG. 10 a further exemplary embodiment of the invention is shown. The following descriptions are substantially limited to the differences between the exemplary embodiments, wherein relative to components, features and functions remaining the same, reference can be made to the description of the exemplary embodiment of FIGS. 1 to 9. To differentiate between the exemplary embodiments, the letter a in the reference signs of the exemplary embodiment in FIGS. 1 to 9 is replaced by the letter b in the reference signs of the exemplary embodiment in FIG. 10. Relative to components denoted the same, in particular relative to components having the same reference signs, in principle reference can also be made to the drawings and/or the description of the exemplary embodiment of FIGS. 1 to 9.

FIG. 10 shows a further exemplary embodiment of an induction energy transmission system 10b in a schematic view. The induction energy transmission system 10b comprises a support plate 12b and a supply unit 14b. The supply unit 14b is arranged below the support plate 12b. The supply unit 14b comprises at least one supply induction element 16b for inductively providing energy. In the present case, the supply unit 14b comprises a total of two supply induction elements 16b. The induction energy transmission system 10b comprises a control unit 18b which in an operating state controls the supply unit 14b and supplies it with energy. The control unit 18b comprises an inverter (not shown) for controlling and supplying energy to the supply unit 14b. The control unit 12b in the operating state supplies the supply unit 14b with electrical energy in the form of a supply alternating current (not shown), the frequency thereof corresponding to a switching frequency (not shown) by which the control unit 12b operates the inverter.

The control unit 18a modulates in the operating state the switching frequency within a modulation period by means of at least one frequency modulation. In the present case, the modulation period corresponds to an integer multiple of a half period of a mains AC voltage. Regarding the frequency modulation of the switching frequency by the control unit 18b, reference can be made to the above description of FIGS. 2 to 9 of the above exemplary embodiment.

In contrast to the above exemplary embodiment, the induction energy transmission system 10b is configured as a small household appliance supply system and comprises a small appliance supply unit 48b. The small appliance supply unit 48b comprises the control unit 18b and a supply unit 14b. A support plate 12b of the induction energy transmission system 10b is configured as a kitchen counter-top 164b.

The induction energy transmission system 10b comprises a small household appliance 20b to be placed on the support plate 12b. The small household appliance 20b has a receiving induction element 24b for receiving the energy provided inductively by the supply induction element 16b of the supply unit 14b. In the present case, the small household appliance 20b is configured as a food processor 52b. The induction energy transmission system 10b in the present case has a further small household appliance 22b. The further small household appliance 22b also comprises a receiving induction element (not shown) for receiving the energy inductively provided by the supply induction element 16b of the supply unit 14b. The further small household appliance 20b is configured as a toaster 166b.

The induction energy transmission system 10b has a communication unit 156b for wireless communication between the control unit 18b and the small household appliance 20b and/or the further small household appliance 22b. The communication unit 156b has a communication element 158b which is connected to the control unit 18b and two further communication elements 160b, 162b which are arranged in the small household appliance 20b or in the further small household appliance 22b. In the present case, the communication unit 156b is configured as an NFC communication unit and for wireless communication by NFC between the control unit 18b and the small household appliance 20b and/or the further small household appliance 22b.

### REFERENCE SIGNS

10 Induction energy transmission system
12 Support plate
14 Supply unit
16 Supply induction element
18 Control unit
20 Small household appliance
22 Further small household appliance
24 Receiving induction element
26 Switching frequency
28 Modulation period
30 Half period
32 Mains AC voltage
34 Modulation interval
36 Modulation interval
38 Modulation profile
40 Parameter
42 Impedance
44 Intermediate modulation period
46 Cooktop
48 Small appliance supply unit
50 Parameter
52 Food processor
54 Kettle
56 X-axis
58 Y-axis
60 Period
62 X-axis
64 Y-axis
66 Supply alternating current
68 Average switching frequency
70 X-axis
72 First portion
74 Second portion
76 Axis of symmetry
78 First further modulation profile
80 First further modulation period
82 Second further modulation profile
84 Second further modulation period
86 Third further modulation profile
88 Third further modulation period
90 Fourth further modulation profile
92 Fourth further modulation period
94 X-axis
96 Y-axis
98 First sub-portion
100 First portion
102 Second sub-portion
104 Third sub-portion
106 Axis of symmetry
108 Second portion
110 X-axis
112 Y-axis
114 First portion
116 Second portion
118 Axis of symmetry
120 X-axis
122 Y-axis
124 Power
126 X-axis
128 Y-axis
130 Frequency value range
132 Excess
134 Deficit
136 X-axis
138 Y-axis
140 X-axis
142 Y-axis
144 Excess
146 Deficit
148 Intermediate modulation profile
150 First method step
152 Second method step
154 Cooktop plate
156 Communication unit
158 Communication element
160 Further communication element
162 Further communication element
164 Kitchen counter-top
166 Toaster
168 Y-axis

1-14. (canceled)

15. An induction energy transmission system, comprising:
a support plate;
a supply unit arranged below the support plate and including a supply induction element for inductively providing energy;
a household appliance for placement on the support plate, said household appliance comprising a receiving induction element designed to receive the inductively provided energy; and
a control unit designed to supply the supply unit with energy and to modulate in an operating state a switching frequency for controlling the supply unit within a modulation period by frequency modulation.

16. The induction energy transmission system of claim 15, constructed in a form of an induction cooking system.

17. The induction energy transmission system of claim 15, wherein the modulation period corresponds to an integer multiple of a half period of a mains AC voltage.

18. The induction energy transmission system of claim 15, wherein the modulation period has at least two modulation intervals which each correspond to an integer multiple of a half period of a mains AC voltage.

19. The induction energy transmission system of claim 18, wherein the at least two modulation intervals are different from one another.

20. The induction energy transmission system of claim 15, wherein the control unit in the operating state modulates the switching frequency based on a predefined modulation profile.

21. The induction energy transmission system of claim 20, wherein the modulation profile is capable of being described by a continuous mathematical function.

22. The induction energy transmission system of claim 20, wherein the modulation profile within the modulation period comprises a path which has a linear portion.

23. The induction energy transmission system of claim 20, wherein the modulation profile within the modulation period comprises a path which has an exponential portion.

24. The induction energy transmission system of claim 20, wherein the modulation profile within the modulation period comprises at least two mirror-symmetrical portions.

25. The induction energy transmission system of claim 20, wherein the control unit is designed to vary the modulation profile based on a parameter relating to the household appliance.

26. The induction energy transmission system of claim 25, wherein the supply unit comprises a supply induction element, with the parameter comprising an influence of the household appliance on an impedance of the supply induction element.

27. The induction energy transmission system of claim 15, wherein the control unit in the operating state modulates the switching frequency by a further frequency modulation within an intermediate modulation period which corresponds to a maximum of a half period of a mains AC voltage.

28. The induction energy transmission system of claim 15, further comprising a cooktop designed to include the control unit and the supply unit.

29. The induction energy transmission system of claim 15, further comprising an appliance supply unit designed to include the control unit and the supply unit.

30. A method for operating an induction energy transmission system, the method comprising:
inductively providing energy to a supply unit arranged below a support plate;
transmitting the inductively provided energy to an induction element of a household appliance; and
modulating a switching frequency for controlling the supply unit within a modulation period by frequency modulation.

31. The method of claim 30, wherein the switching frequency is modulated based on a predefined modulation profile.

32. The method of claim 30, wherein the modulation profile is capable of being described by a continuous mathematical function.

33. The method of claim 30, wherein the modulation profile within the modulation period comprises a path which has a linear portion.

34. The method of claim 30, wherein the modulation profile within the modulation period comprises a path which has an exponential portion.
